(19) United States
(12) Patent Application Publication
(10) Pub. No.: US 2014/0063261 A1
(43) Pub. Date: Mar. 6, 2014

(54) PORTABLE DISTANCE MEASURING DEVICE WITH A LASER RANGE FINDER, IMAGE SENSOR(S) AND MICRODISPLAY(S)

(71) Applicant: Pocket Optics, LLC, Cedar Park, TX (US)

(72) Inventors: Ellis I. Betensky, Toronto (CA); Daniel A. Coner, Winder, GA (US); Richard N. Youngworth, Boise, ID (US); Gregory Scott Smith, Cedar Park, TX (US)

(73) Assignee: Pocket Optics, LLC, Cedar Park, TX (US)

(21) Appl. No.: 14/012,927

(22) Filed: Aug. 28, 2013

Related U.S. Application Data
(60) Provisional application No. 61/694,562, filed on Aug. 29, 2012.

(51) Int. Cl. G01C 3/08

(52) U.S. Cl. CPC G01C 3/08
USPC 348/158

(57) ABSTRACT

Portable laser rangefinders include an objective lens situated to form an image of a distant object on an image sensor. The image sensor is coupled to a display that produces a corresponding displayed image that can be viewed directly by a user, or viewed using an eye piece. A transmitter directs a probe beam to a target, and a returned portion of the probe beam is detected to estimate target distance or target speed. An image processor is coupled to the image sensor and the display so as to provide a digital image.

### CROSS REFERENCE TO RELATED APPLICATION

This application claims the benefit of U.S. Provisional Application 61/694,562, filed Aug. 29, 2012, which is incorporated herein by reference.

### FIELD

The disclosure pertains to portable laser range finders.

### BACKGROUND

There are many devices used for magnified viewing, recording, and measuring distance and speed of distant objects. One such device is a laser range finder, where the range to a distant object is measured by emitting light from a source at the device and determining the amount of time required for the emitted light to travel to and reflect from the distant object and be received at the location of the emitting source. Typically, the light source is a laser emitting light in pulses, and the time of flight is determined by counting received pulses. Another similar device is a LIDAR gun used to detect the speed of vehicles, and is substantially similar to a laser range finder used for hunting and golf. The LIDAR gun takes several range measurements over a very short time interval to determine the speed of the target object.

Handheld laser range finders are often employed by hunters and golfers to determine distance. Such laser range finders are comprised of an objective lens that focuses light from the object to an aerial image which is then viewed by the user with the aid of a magnifier or eyepiece. These laser range finders employ one of two methods for displaying information about the aiming reticle and object distance. The first method involves the use of a transmissive LCD which displays the reticle and distance measurement data on a LCD screen. The second method involves the use of projected LEDs, where the information is projected or superimposed in the optical path.

LIDAR guns employ an even simpler aiming method by using a small telescope or heads-up display with a reticle in order to aim the LIDAR gun at the appropriate target. The speed of the targeted vehicle is then displayed on an external, direct view display.

The conventional laser range finders described above have limited performance, both in seeing distant objects and in viewing necessary information. First, conventional laser range finder systems have a low magnifying power that cannot be varied for different conditions; furthermore they do not have an image recording capability. Because the exit pupil of the system must be necessarily large for viewing, the entrance pupil diameter which is approximately the front lens diameter, must equal the exit pupil diameter times the magnifying power. Thus the entrance pupil and objective lens diameter will become increasingly large for distant viewing of game animals, vehicles, trees, golf pins or other terrain. Regarding information displayed on an LCD screen, this approach works well in some environments, but only approximately 30% of the light is transmitted through the device. Consequently, it is not easy to read in low light environments and the projected LED display becomes invisible in bright ambient light situations, such as in the middle of the day or in high albedo environments such as snow.

Another shortcoming of conventional devices is that hunters or golfers may want to take pictures or shoot video while using the device. Conventional laser range finder monoculars and binoculars have no means of capturing still or video images.

LIDAR guns have no integrated method of capturing a picture of the targeted vehicle along with the speed of the vehicle. Some newer LIDAR guns use an attached camera to record images, but the camera is typically not integrated nor used as the aiming method for the operator, and thus introduces a source of error as the attached camera may capture an image of a vehicle that was not targeted by the speed detection system.

### SUMMARY

According to some examples, measuring devices comprise an electronic image sensor and an objective lens forming an image of a distant object onto the electronic sensor. An image processor is coupled to the electronic sensor and coupled to an image display so as to produce a displayed image corresponding to the image formed by the objective lens. An eye lens is situated so as to magnify the displayed image for a user. In typical examples, users are hunters, golfers or others who measure object speed, distance, or trajectory. A light source and collimating lens are situated to project a light beam onto an object for which the distance and speed is to be measured. A receiving lens is situated to collect light from said light source returned by the object, and direct the collected light to a sensor. A timing circuit is configured to determine a time required for the light to travel from the device to the object, and calculate the distance to the object, or the speed the object is travelling. In some examples, a maximum magnifying power of the measurement device is greater than 0.7× the entrance pupil diameter of the objective lens in millimeters. In some embodiments, more than one of the functions of the objective lens, collimating lens and receiving lens components are combined and performed by only one component. In typical examples, the measurement device includes a microphone, an ambient light sensor, a proximity sensor, computer or handheld device, and/or input/output ports. In other examples, an anchor is provided for a tether and/or a threaded tripod mount. In still further examples, a wireless transceiver is configured to communicate device control data, image data, or measurement data. In other example, external storage connections are provided so as to store images or video in removable memory. In some examples, an autofocus system is coupled to the objective lens, and a removable infrared light filter is situated in front of the image sensor to facilitate viewing of images in low light or nighttime environments.

In still other alternatives, a target tracking and identification system is provided to synchronize the distance and/or speed measuring system with an identified target on the image sensor such that the measurement device automatically initiates a distance measurement when the identified target passes through a center or other predetermined portion of the image sensor in order to aid distance measurement when a user is unstable or in motion. In yet other examples, additional image sensors for visible light and infrared light are provided, and a visible image, an infrared image and/or a combined image is displayed. According to other examples, a second eyepiece is provided for binocular (stereoscopic) vision or biocular vision. In other embodiments, a motion sensor is configured to detect when the device is no longer in use in order to turn off the device to conserve power, or a GPS receiver and GPS mapping software for determining location.

The foregoing and other objects, features, and advantages of the invention will become more apparent from the following detailed description, which proceeds with reference to the accompanying figures.

### BRIEF DESCRIPTION OF THE DRAWINGS

FIGS. 1-2 are perspective views of a laser range finder.

FIG. 3 is a block diagram of a laser ranger finder.

FIG. 4 is a schematic diagram of a laser receiver (Rx) such as included in the block diagram of FIG. 3.

FIG. 5 is a schematic diagram of a laser transmitter (Tx) such as included in the block diagram of FIG. 3.

FIG. 6 is a block diagram of a laser ranging system.

FIGS. 7-8 illustrate objective lens systems.

FIG. 9 illustrates a zoom objective lens system showing three zoom positions.

FIG. 10 illustrates an additional example of an objective lens system.

FIGS. 11-12 illustrate representative eye lens systems.

FIGS. 13-14 illustrate laser transmitter system optics.

FIGS. 15-16 illustrate laser receiver system optics.

FIG. 17 illustrates a representative method of establishing range finder characteristics.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Some examples are described with reference to an axis or an optical axis along which optical elements such as lenses are arranged. Such axes are shown as lines or line segments, but in other examples, axes can comprise a plurality of line segments so that an optical axis can be bent or folded using prisms, mirrors, or other optical elements. As used herein, “lens” refers to single refractive elements (singlets) or multi-element lens systems.

The conventional system described above cannot be adapted to be used as a compact, handheld laser range finder or LIDAR gun with variable magnification and a large exit pupil diameter because it would be too large. Instead, by forming an image of a distant object onto an electronic sensor, such as a CCD or CMOS image sensor, electronically processing the captured image, and electronically relaying the image to a small display device viewed with a magnifying eye lens, the overall size can be significantly reduced. The disclosed apparatus and method can also overcome the other aforementioned shortcomings. Furthermore, other features, including the following can be realized: autofocus, zooming, image stabilization, and image and video capture. The device can utilize one or more image sensors as well as one or more eyepieces in order to function as a either a monocular laser range finder, a LIDAR gun, or a binocular laser range finder. Additional features may include a microphone for annotating images and video, a GPS receiver for determining location of the device and location of the target object, gyroscope(s) for image stabilization, an inclinometer for measuring angle or tilt, a compass or magnetometer for determining heading, environmental sensors such as temperature, pressure and humidity, and wireless transceivers for configuring and downloading images from the device. A ballistic computer may also be employed to assist a hunter in determining the proper holdover or horizontal range to a target, or a golfing computer to assist users in club selection based on the distance and angle to the green. Since most modern digital image recording devices utilize an IR cut filter to improve the color saturation of an image during the daytime, the device may also employ a removable IR cut filter to support low light or nighttime image recording performance. In addition to a removable IR cut filter, an external IR LED or IR laser diode may be utilized to augment nighttime image recording capabilities.

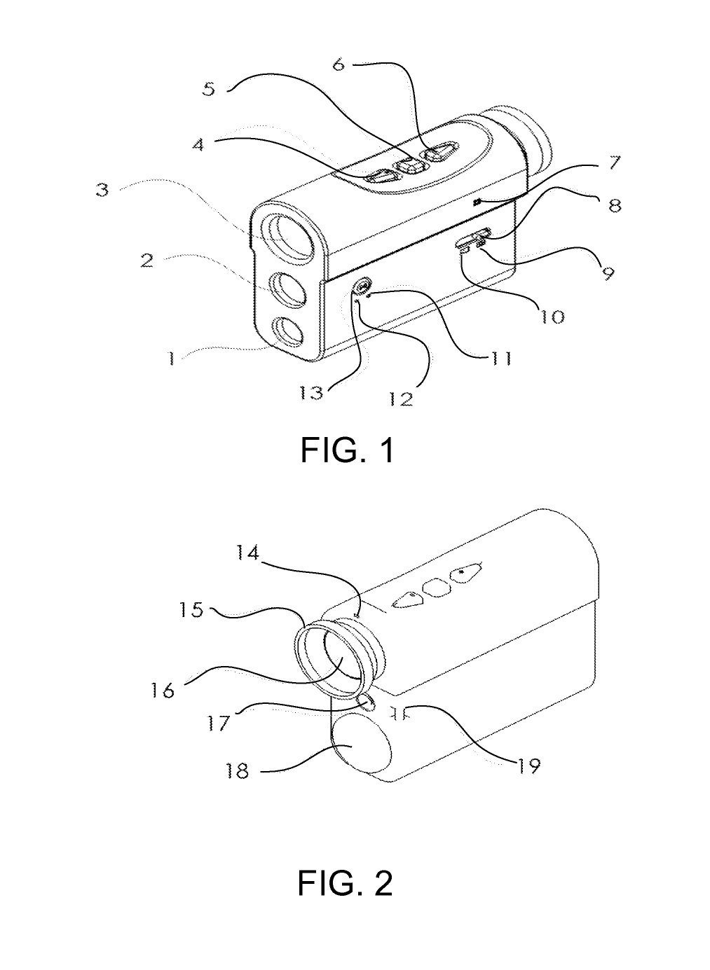

FIG. 1 is a perspective view of a laser range finder that comprises laser transmitter collimating optics 1 for focusing the emitted light, laser receiving optics 3 for collecting and focusing the reflected light on a light sensor, and an objective lens 2 for focusing an image of a distant object. User control functions can be provided with, for example, an increase zoom button 4, a decrease zoom button 6, a range button 5, a menu configuration and start and stop image capture button 13, and a still image or video mode selector 8. A microphone 7 or environmental sensors may be exposed through the housing of the device. Additional visual marks such as a start record icon 12, a stop record icon 11, a video mode icon 10 or a still image mode icon 9 may be included.

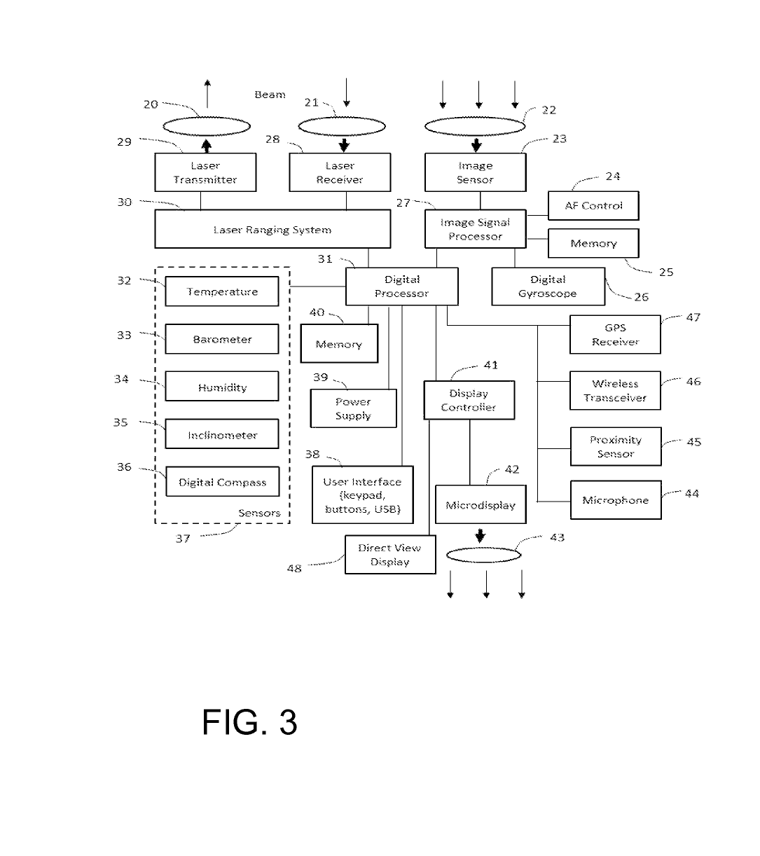

FIG. 2 is a perspective view of the laser range finder of FIG. 1 showing an eyepiece or ocular 16 for viewing a display, an eyecup 15 for shielding the eye or adjusting diopter focus. An ambient light sensor and proximity sensor 14 is coupled so as to sense ambient light so that display brightness is adjusted, or to turn off the display when not in use. A wireless button 17 is provided for configuration and image download, and an anchor point 19 is configured for attaching a tether. A battery is provided for power and enclosed by a battery cover 18. FIG. 3 shows a block diagram of a laser range finder. The device contains at least one objective system 22 for focusing images of distant objects onto at least one image sensor 23. The device further contains an image signal processor 27 for processing images and formatting them for storage in memory 25 or some additional storage device (not shown). The device further contains an autofocus control system 24 and at least one digital gyroscope 26 to support image stabilization. The device further contains a laser ranging system 30 that controls the laser transmitter 29 and laser receiver 28 for determining the range between the device and distant objects. The emitted light from the transmitter 29 is collimated through a lens system 20 and reflected light is focused through a receiver lens 21 onto a light sensor associated with the laser receiver 28.

The device contains at least one processor 31 for controlling the overall device and connected to a power supply system 39, and may be connected to environmental sensors 37 (32-36), a GPS receiver 47, a wireless transceiver 46 for configuration or downloading of images and video, a display controller 41, additional memory 40 for storage of software or data, an ambient light and proximity sensor 45 for adjusting the brightness of an external direct view display 48 or internal microdisplay 42, or for turning off the external or internal display, a magnified eyepiece lens system 43 in order to display images and information to a user. The block diagram also shows user interface controls 38 which may include buttons, levers, switches, knobs, and other input mechanisms including input/output ports such as USB and memory card slots. A microphone 44 is provided for audio input.

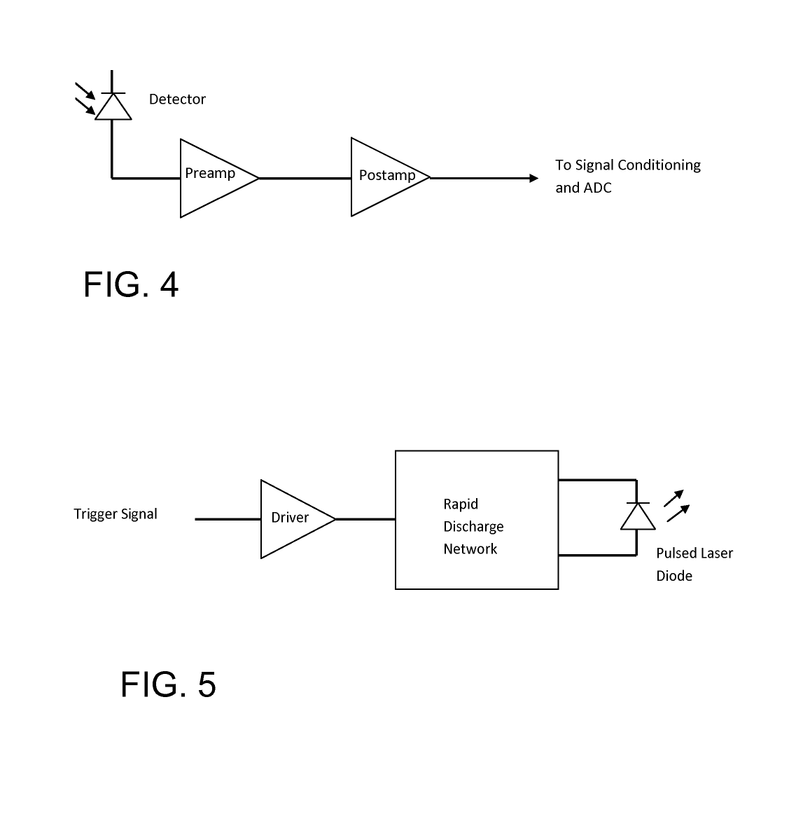

An alternative embodiment may use a direct view display instead of magnifying the image of a small display, leveraging high resolution AMLCD or AMOLED displays mounted to the exterior of the device. By utilizing an external, direct view display the user can avoid the complication of diopter adjustments commonly found on oculars. FIGS. 4-5 illustrate a representative laser receiver and transmitter, respectively.

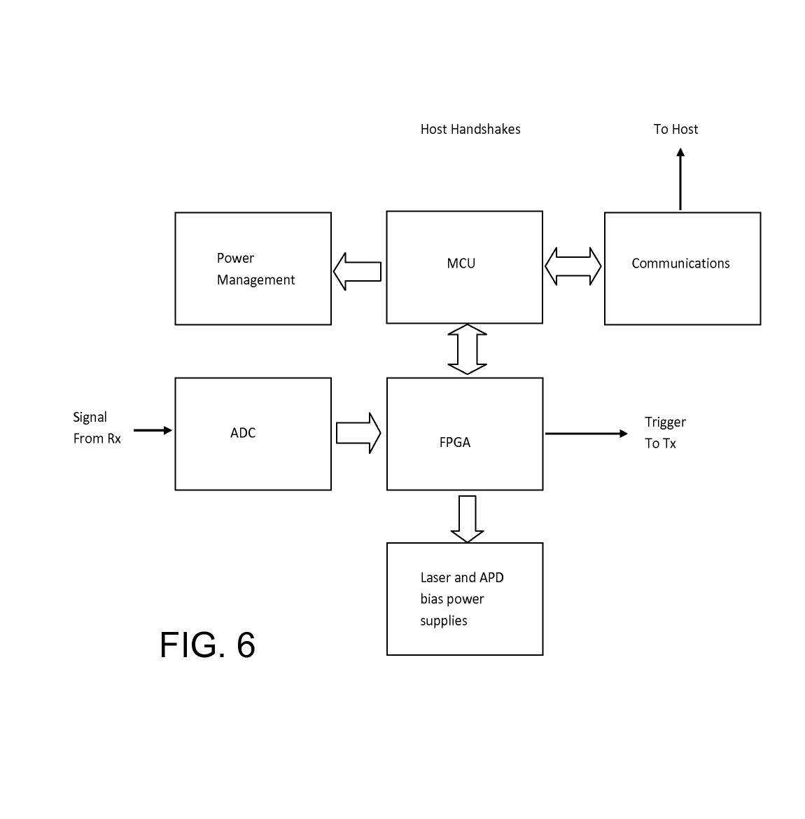

FIG. 6 is a simplified block diagram of a rangefinder processing system that includes an analog to digital convertor (ADC) that is coupled to a photodetector 18 that receives a portion of a returned probe beam. The ADC is coupled to an FPGA that is configured to establish laser and detector (typically, avalanche photodiode (APD) bias and other operating conditions. As shown, the FPGA is configured to couple a transmitter trigger signal to a transmitter. A microcontroller (MCU) is coupled to a power management system and a communications system so as to send and receive data and configuration parameters.

Image capture, processing and display functionality can be provided with components that are similar or the same as those used in commercial digital video cameras. High resolution sensors, such as the Omnivision OV16825 16 MP image sensor, may be used for image capture. Image processing can be performed with a high speed field programmable gate array (FPGA) or by using a commercial system on a chip (SOC) such as the Ambarella A5S processor. The SOC integrates such functions as video and audio compression, image processing, color correction, autofocus control, memory, image stabilization with gyroscopic input and display formatting. Once an image is processed it can be displayed on an internal microdisplay, such as the MicroOLED MDP01B OLED display, or displayed on an external AMOLED or AMLCD display as commonly found on smartphones. The SOC may also accept audio input from a microphone in order to record voice or game noise in combination with the image capture.

The effective digital zoom is defined as the maximum ratio that can be obtained by comparing the usable pixels in the image sensor and display. The effective digital zoom is specifically defined as: Maximum[Minimum(sh/dh, sv/dv), Minimum(sh/dv, sv/dh)], where the number of pixels is sh for the image sensor in the horizontal dimension, sv for the image sensor in the vertical dimension, dh for the display in the horizontal dimension, and dv for the display in the vertical dimension. The pairing can be mechanically rotated in the device as appropriate to match the maximum digital zoom condition. As a numerical example, consider the Omnivision OV10810 image sensor (4320×2432) and the MicroOLED MPD01B microdisplay (854×480). Hence sh is 4320, sv is 2432, dh is 854, and dv is 480. The maximum digital zoom is Maximum[Minimum(4320/854, 2432/480), Minimum(4320/480, 2432/854)] or 5.06 times magnification. The objective system may employ additional optical zoom by moving lenses to increase the total magnification range of the system.

The objective of the device may be focused manually or by using an appropriate device such as an autofocus control method, such as a voice coil motor, stepper motor, MEMS actuator, piezoelectric actuator, artificial muscle actuator or liquid lens system positioned along the optical axis. Hence, autofocus can be achieved by whatever methods and apparatus are suitable for the product design such as lens movement, sensor movement, or a variable power part such as a liquid lens.

Laser rangefinder and speed detection circuitry typically use an infrared laser, such as the Osram SPL PL90_{—}3 pulsed laser diode, to transmit one or more short pulses of light at the target of interest. Reflected light is then received using a photosensitive sensor, such as the Excelitas C30737PH-230-92 avalanche photodiode, to detect the return pulse(s). By using a precision time of flight circuit or advanced signal processing techniques, the distance to or the speed of a distant object can be calculated.

A general purpose microcontroller (MCU) can be used to synchronize the image processing and distance and speed measurement system in order to capture images during each ranging or speed detection interval. This information is stored in memory. The MCU is also used to sample environmental sensors, such as temperature, pressure, humidity, incline angle, geo-positional location and magnetic heading. This information may be used for ballistic calculation or target location identification. The MCU may also use an ambient light and proximity sensor to control display brightness, or to turn the display off when not in use and may be used in combination with a motion sensor to turn the entire device off when not in use.

Interface controls such as buttons, knobs, touch displays and other user interface controls can be provided to operate the device. The user interface controls are used to zoom the magnification up or down, focus the image, range the target, detect the speed of a target, capture images and configure the device.

Systems and apparatus can be configured for use as a general purpose still camera, camcorder, laser rangefinder or as a LIDAR gun for speed detection depending upon the user configuration.

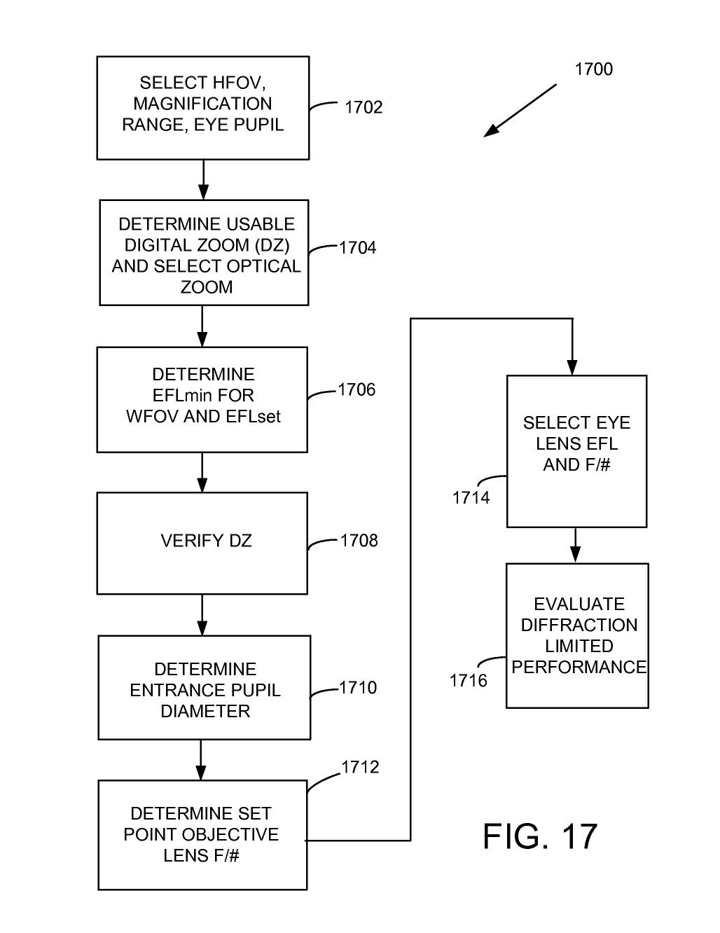

A representative method 1700 for determining matched system specifications for the objective and eye lens in the system, based on physics constraints driving requirements that can achieve diffraction-limited visual performance at both the maximum magnification and wide zoom position field-of-view, is shown in FIG. 17 and is described below. At 1702, a desired objective half field-of-view (HFOVobj) looking out at a scene (can be corner horizontal, or vertical) is chosen and can be defined for any magnifying power setting (widest will be at the lowest magnifying power, HFOVwobj). A range of magnifying power for the instrument can be chosen in absolute terms (MPmin to MPmax, wide to narrow field of view respectively), and a size (CAeye) and a location of eye lens pupil (where the eye is placed in use) are selected. At 1704, a usable digital zoom range for a sensor and display pairing is calculated if digital zoom is to be used based on a formula for effective digital zoom. Effective digital zoom is Maximum[Minimum(sh/dh, sv/dv), Minimum(sh/dv, sv/dh)], wherein the number of pixels is sh for the image sensor in the horizontal dimension, sv for the image sensor in the vertical dimension, dh for the display in the horizontal dimension, and dv for the display in the vertical dimension. A digital zoom (DZ) range that will be employed is selected based on engineering considerations such as image stabilization and demosaicing in image processing:

MP=DZe×MPmin,

wherein DZe ranges from 1 to the maximum employed value DZmax (wide to telecentric zooming mode), MP is magnifying power, and MPmin is the minimum magnifying power. An optical zoom range required to cover the magnifying power range is determined if the employed digital zoom range is insufficient. MPtot=MP×Zopt, wherein Zopt is the optical zoom and other parameters as previously defined. In such cases where optical zoom is needed, calculations can be done for additional zoom positions required to cover the complete specified magnification zoom range.

At 1706, a wide FOV effective focal length (EFLmin) is calculated so as to fit a chosen sensor:

EFLmin=HDsens/tan(HFOVwobj),

wherein HDsens is a corresponding sensor half-dimension in the objective HFOVwobj wide field of view defined dimension. A set point for the objective design effective focal length is selected so as to have a sufficiently long effective focal length to deliver diffraction-limited sensor element mapping to the scene:

EFLset=DZset×EFLmin,

wherein the pixel-mapping constraint is EFLset>=[sps/(Er/MPmax)], wherein EFLset is the objective focal length for design, DZset is the digital zoom offset required to satisfy the pixel mapping constraint (and can be chosen to exceed the equality constraint in magnitude), sps is the sensor effective pixel size, Er is the resolution capability of the eye, and MPmax is the maximum magnifying power in the range.

At 1708, the specific digital zoom numbers are evaluated so as to verify matching of the low to high magnifying power range provided by digital zoom based on the objective lens effective focal length set point:

DZmin<=DZset<=DZmax,

wherein DZmin is 1, DZmax and DZset are as previously defined, and the digital zoom ratio is proportional to the ratio of equivalent digital EFL values at different MP (digital equivalent EFL EFLdigeq=DZe EFLmin where EFLmin=EFLset/DZset as DZmin=1).

At 1710, a minimum objective entrance pupil diameter is calculated to ensure proper resolution from angular diffraction and eye resolution constraints. Such checking can be based on Sparrow or Rayleigh criteria depending on system design. For the Rayleigh criteria, MPres=Er×(60/5.5)×CAent, wherein Er has been previously defined, CAent is the clear aperture of the entrance pupil of the objective in inches, and MPres is the maximum diffraction-limited resolving power.

At 1712, a set point objective lens design f-number is calculated with the given entrance pupil diameter and set point effective focal length:

f-number=EFLset/CAent,

wherein EFLset and CAent are as previously defined.

At 1714, an eye lens effective focal length is calculated based on the set point magnifying power and field-of-view:

EFLeye=HDdisp/[MPmin×tan(HFOVwobj)],

wherein HDdisp is the corresponding display half-dimension in the objective HFOVwobj defined dimension, and MPmin has previously been defined. An eye lens f-number is calculated based on eye lens pupil size and effective focal length:

f-number=EFLeye/CAeye,

wherein EFLeye and CAeye are defined above.

At 1716, objective and eye lens diffraction-limited performance for the given f-numbers is evaluated to determine that suitable (in some cases, ideal performance) is achievable with the selected parameters. For example, using the modulation transfer function as a meaningful system metric, MTFdiffn(v/vc)=(2/Pi)×[arcos(v/vc)−(v/vc)×sqrt(1−(v/vc)̂2)], wherein v is the spatial frequency in cycles per mm and vc=1/(wavelength×f-number); the modulation up to the Nyquist frequency of the sensor should provide overhead in performance for the invention.

Diffraction is a physics-driven constraint, the wavelength is determined by the desired viewing spectrum, eye considerations are determined by the targeted viewing population, the display numerical aperture (NA) should sufficiently illuminate the entrance pupil to the eye lens (on the display side), and the physical pixel sizes are image sensor and display specific quantities.

Variants of the disclosed method for determining objective and eye lens specifications are also possible. All of the appropriate relationships can be modified to compute the parameters chosen in the method above when computed values are instead chosen as a degree of freedom. For example, the objective EFL or f-number can be chosen for the set point. Then the field of view for the objective can be calculated given by rearranging the expressions above. It is also possible to iterate between steps in the given method, design to limit and maximize performance for digital zoom, or to use a subset of the available digital zoom (even adjusting the DZmin value to be greater than unity). These sample variants are straightforward given the disclosed method.

As an example of the method in use, consider a grayscale sensor (4000×2000, 2 μm sized pixels) and the microdisplay (1000×500, 10 μm sized pixels). First a desired HFOV of 11 meters at 100 meters distance in the horizontal dimension at the wide field of view zoom is chosen. This is a horizontal half field of view of 3.15 Degrees. The magnifying power range is next chosen to be MPmin=3 and MPmax=12. The CAeye is chosen to be 6 mm and the eye relief is 25 mm. With the given sensor and display parameters, the effective digital zoom DZmax is computed to be 4. In this case all of the digital zoom will be utilized and no optical zoom is required to cover the range, as MPmax=DZmax×MPmin=4×3=12. The objective lens EFLmin is directly calculated to be 4 mm/arctan (3.15 Degrees)=72.7 mm. EFLset=EFLmin and DZset=1 can be used in this case because the mapping constraint is that EFLset>=41.3 mm. Since the set point is at the unity digital zoom DZset=DZmin=1, verifying the digital zoom numbers match the low to high magnifying power range is straightforward as the MP range matches the earlier calculation MPmax=DZmax×MPmin=4×3=12. Using the Rayleigh criteria for the maximum MP range, the CAent for the objective lens is chosen to be 14 mm which yields a maximum possible diffraction-limited magnifying power of MPres=12.02. The set point f-number of the objective is then 72.7 mm/14 mm=f/5.19. The eye lens EFL is EFLeye=5 mm/[3×tan(3.15 Degrees)]=30.3 mm. The f-number of the eye lens is then 30.1 mm/6 mm=f/5.05. The final check is a function of the specific product image requirements and is hence only mentioned but not shown for this example. These design parameters can be adjusted as needed to accommodate product requirements.

The laser transmitter lenses are designed to collimate a laser or laser diode to a well-collimated number, such as less than 2 milliradians of divergence. The receiver lenses are designed with a divergence of approximately 20% larger field of view, in other words 20% more acceptance angle, than the transmitter lens' divergence. Further considerations of the receiver and transmitter design layouts are driven by packaging and manufacturability.

During assembly, the laser transmitter system, the laser receiver system and objective system are carefully aligned such that the laser emitter is centered on both the avalanche photodiode and the image sensor.

In some embodiments, power is provided by one or more batteries. Primary Lithium batteries such as a CR123 or CR2, Lithium AA cells or rechargeable batteries may be used. The device is normally in an off state and can be turned on by pressing the range or fire button. Once pressed, the device displays an aiming reticle on an internal or external display and focuses the image of the target. The operator then presses the range or fire button to calculate a range to or speed of a distant object. This distance is then shown on the display. The magnification of a distant image can be increased or decreased by pressing one or more buttons on the device. Furthermore, the invention can be configured to record the image of the target being ranged for distance or velocity. An additional button or user control can be toggled between distance measurement, speed detection, still image capture or video capture depending upon the operator's configuration.

Representative optical system embodiments are set forth below with the following definitions. Spectra are visible for objective and eye lens; 905 nm for transmitter and receiver. Fields of view are given in degrees (HFOV is half field of view), Entrance Beam Radius is EBR, Effective Focal Length is EFL, AST signifies aperture stop. Dimensions are in mm. In the accompanying drawings, radii of curvature of optical surfaces are indicated as R1, R2, R3, etc., element thickness are indicated as T1, T2, T3, etc., and element materials designated as Schott Optical Glass are indicated as U1, U2, U3, etc., with the exception of air spaces with are not provided with such indications.

### EXAMPLE 1

### Objective System

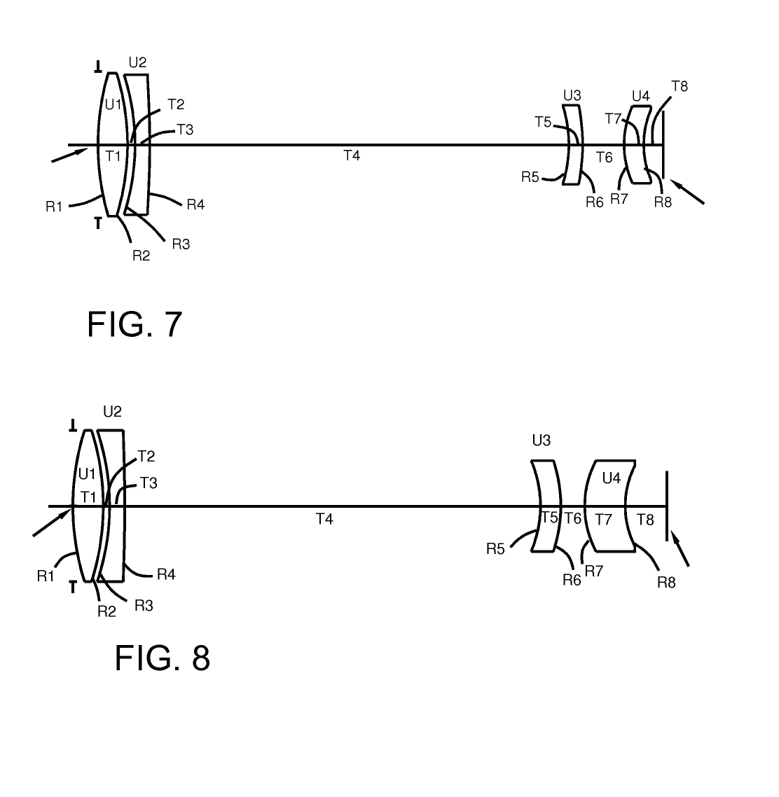

In the example, scene is to the left and a sensor is to the right as shown in FIG. 7. For this example, HFOV=3.57, EBR=7.5, EFL=55.6, and the objective distance is infinity. System data is in Table 1.

TABLE 1

| | | | Aperture | |
|---|---|---|---|---|
| Surface | Radius | Thickness | Radius | Medium |
| 1 | 26.07 | 3 | 7.31 | FK5 |
| 2 | −24.92 | 0.77 | 7.32 | |
| 3 | −23.5 | 1.5 | 7.17 | N-F2 |
| 4 | −105.99 | 42.67 | 7.14 | |
| 5 | −13.47 | 1.4 | 3.98 | N-FK5 |
| 6 | −21.26 | 4.23 | 4.04 | |
| 7 | 9.56 | 2 | 3.95 | N-LASF44 |
| 8 | 9.11 | 2 | 3.55 | |

### EXAMPLE 2

### Objective System

In example 2, a scene is to the left and sensor to the right as shown in FIG. 8. For this example, HFOV=3.57, EBR=7.5, EFL=55.6, and the objective distance is infinity. System data is in Table 2.

TABLE 2

| | | | Aperture | |
|---|---|---|---|---|
| Surface | Radius | Thickness | Radius | Medium |
| 1 | 24.75 | 3 | 7.5 | N-PK52A |
| 2 | −24.75 | 0.62 | 7.5 | |
| 3 | −23.56 | 1.5 | 7.5 | N-KZFS4 |
| 4 | −178.82 | 41 | 7.5 | |
| 5 | −11.53 | 2 | 4.5 | N-LASF44 |
| 6 | −14.47 | 2.37 | 4.5 | |
| 7 | 9.65 | 4 | 4.5 | N-FK5 |
| 8 | 8.88 | 4.11 | 4 | |

### EXAMPLE 3

### Zoom Objective Lens

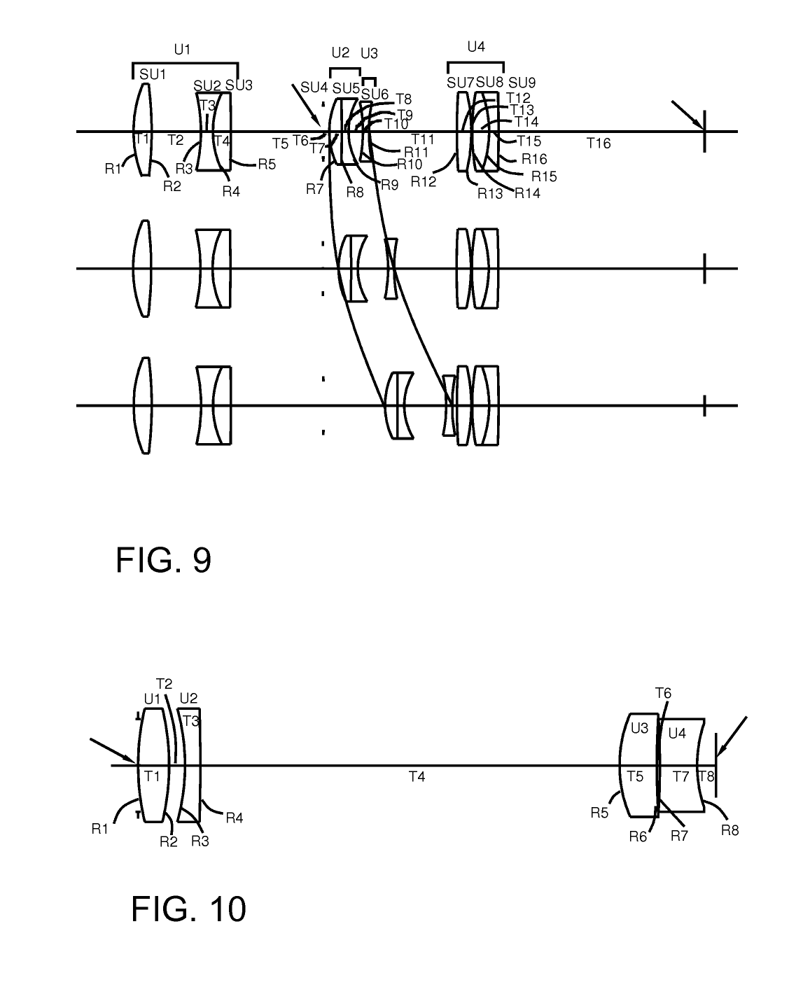

In this example, a scene is to the left and a sensor to the right as shown in FIG. 9. In a wide zoom configuration, HFOV=3.64, EBR=7.6, EFL=55.0. In a mid-zoom configuration, HFOV=2.05, EBR=7, EFL=70.0. In a zoom telephoto configuration, HFOV=0.93, EBR=7.5, EFL=108.0. The stop is 1 mm in the object direction from surface 6. The object distance is infinity.

The wide zoom configuration (configuration 1) is described in Table 3, Table 4 lists settings for the mid-zoom configuration (configuration 2) and the zoom telephoto configuration (configuration 3).

TABLE 3

| | | | Aperture | |
|---|---|---|---|---|
| Surface | Radius | Thickness | Radius | Medium |
| 1 | 20.87 | 3 | 8 | N-FK5 |
| 2 | −68.93 | 8.22 | 8 | |
| 3 | −27.8 | 2 | 6.5 | KZFSN5 |
| 4 | 14.89 | 3 | 6.5 | N-FK5 |
| 5 | −235.42 | 15.35 | 6.5 | |
| 6 | Infinity | 1 | 4.34 | |
| 7 | 12.79 | 2.1 | 5.5 | SF11 |
| 8 | −191.41 | 1.1 | 5.5 | F5 |
| 9 | 10.54 | 2.41 | 5.5 | |
| 10 | −24.13 | 1 | 5 | N-LAF21 |
| 11 | 25.65 | 14.63 | 5 | |
| 12 | 110.51 | 2.4 | 6.6 | N-LAK14 |
| 13 | −29.12 | 0.15 | 6.6 | |
| 14 | 38.33 | 2.8 | 6.6 | N-LAK14 |
| 15 | −19 | 1.6 | 6.6 | SF56A |
| 16 | −166.41 | 34.22 | 6.6 | |

TABLE 4

| Configuration | Surface | Parameter | Value |
|---|---|---|---|
| 2 | 6 | Thickness | 2.63 |
| 2 | 9 | Thickness | 5.04 |
| 2 | 11 | Thickness | 10.39 |
| 3 | 6 | Thickness | 10.27 |
| 3 | 9 | Thickness | 6.97 |
| 3 | 11 | Thickness | 0.79 |

### EXAMPLE 4

In example 4, a scene is to the left and a sensor is to the right as shown in FIG. 10. In this example, HFOV=4.15, EBR=5, EFL=48.0, and the object distance is infinity. System data is in Table 5.

TABLE 5

| | | | Aperture | |
|---|---|---|---|---|
| Surface | Radius | Thickness | Radius | Medium |
| 1 | 2.63 | 2.63 | 2.63 | 2.63 |
| 2 | 5.04 | 5.04 | 5.04 | 5.04 |
| 3 | 10.39 | 10.39 | 10.39 | 10.39 |
| 4 | 10.27 | 10.27 | 10.27 | 10.27 |
| 5 | 6.97 | 6.97 | 6.97 | 6.97 |
| 6 | 0.79 | 0.79 | 0.79 | 0.79 |
| 7 | 2.63 | 2.63 | 2.63 | 2.63 |
| 8 | 5.04 | 5.04 | 5.04 | 5.04 |

### EXAMPLE 5

### Eye Lens System

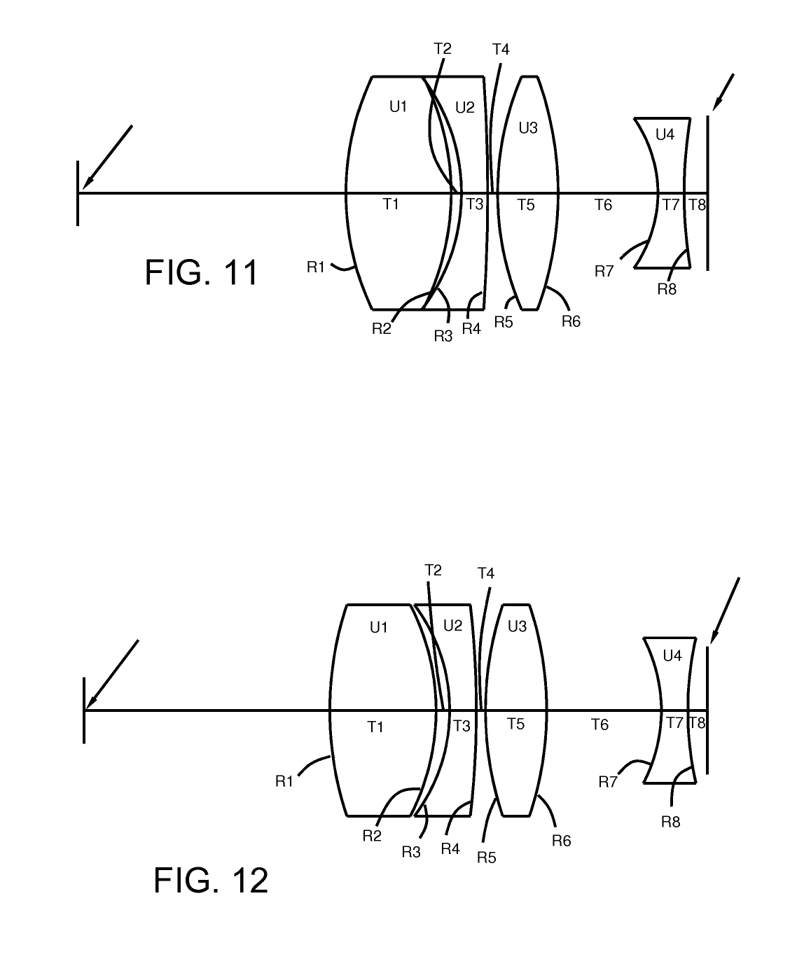

In this example, an eye is to the left and a display is to the right as shown in FIG. 11. In this example, HFOV=17.5, EBR=2.5, EFL=15.25, and the object distance is infinity. The eye pupil is 16 mm in front of surface 1. System data is in Table 6.

TABLE 6

| | | | Aperture | |
|---|---|---|---|---|
| Surface | Radius | Thickness | Radius | Medium |
| 1 | 16.44 | 6.27 | 7 | N-LAK14 |
| 2 | −15.46 | 0.61 | 7 | |
| 3 | −11.54 | 1.57 | 7 | SF57 |
| 4 | −103.27 | 0.6 | 7 | |
| 5 | 17.91 | 3.6 | 7 | N-LAK14 |
| 6 | −20.46 | 5.95 | 7 | |
| 7 | −7.83 | 1.57 | 4.5 | LF5 |
| 8 | 27.84 | 1.43 | 4.5 | |

### EXAMPLE 6

### Eye Lens System

In example 6, an eye is to the left and a display is to the right as shown in FIG. 12. In this example, HFOV=14, EBR=2.5, EFL=19.4, and the object distance is infinity. The eye pupil is 18.5 mm in front of surface 1. System data is in Table 7.

TABLE 7

| | | | Aperture | |
|---|---|---|---|---|
| Surface | Radius | Thickness | Radius | Medium |
| 1 | 25.27 | 8 | 8 | N-LAK14 |
| 2 | −17.47 | 1.03 | 8 | |
| 3 | −13.36 | 2 | 8 | SF57 |
| 4 | −71.87 | 0.7 | 8 | |
| 5 | 25.27 | 4.6 | 8 | N-LAK14 |
| 6 | −25.27 | 8.64 | 8 | |
| 7 | −11.92 | 2 | 5.5 | LF5 |
| 8 | 25.27 | 1.5 | 5.5 | |

### EXAMPLE 7

### Laser Transmitter System

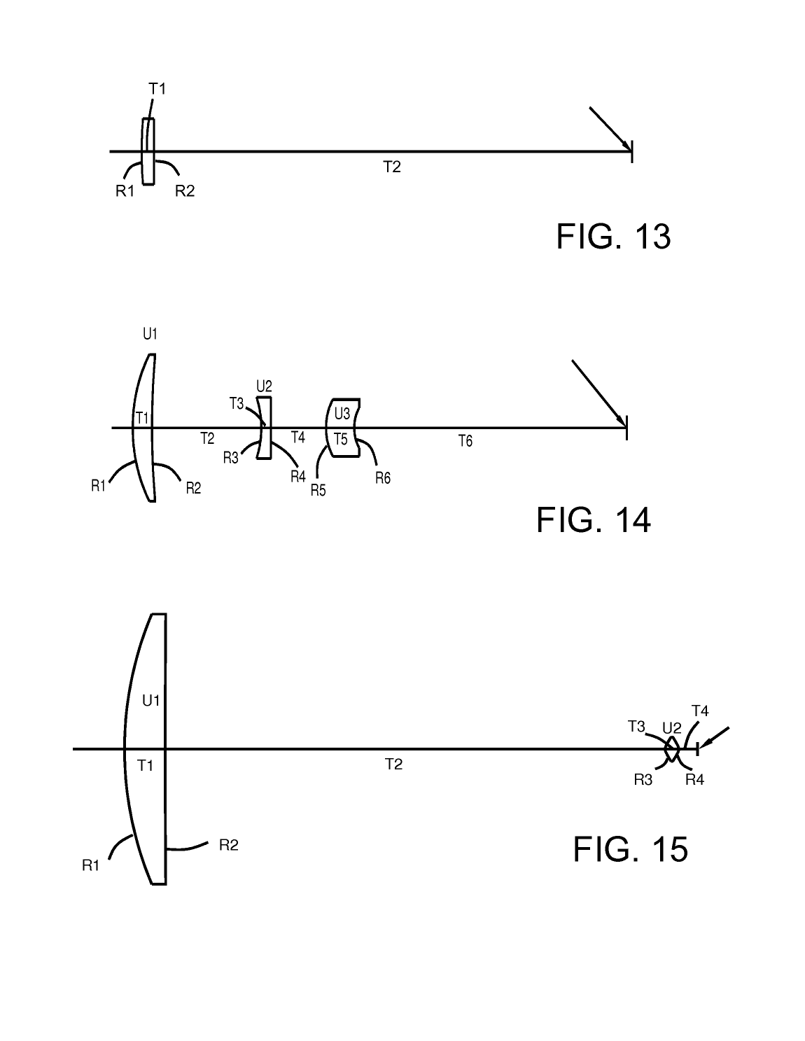

In this example, a scene is to the left and a laser emit is situated to right as shown in FIG. 13. In this example, HFOV=0.0515, EBR=6.00, EFL=120, and the object distance is infinity. System data is in Table 8.

TABLE 8

| | | | Aperture | |
|---|---|---|---|---|
| Surface | Radius | Thickness | Radius | Medium |
| 1 | 61 | 3 | 6.2 | BK7 |
| 2 | Infinity | 117.87 | 6.2 | AIR |

### EXAMPLE 8

### Laser Transmitter System Optics

In this example, a scene is to the left, and a laser emits from the right as shown in FIG. 14. For this example, HFOV=0.0515, EBR=6.00, EFL=120, and the object is at infinity. System data is in Table 9.

TABLE 9

| | | | Aperture | |
|---|---|---|---|---|
| Surface | Radius | Thickness | Radius | Medium |
| 1 | 11.25 | 2 | 6 | N-SF5 |
| 2 | 53.68 | 11.35 | 5.59 | |
| 3 | −6.68 | 1 | 2.5 | N-SF5 |
| 4 | Infinity | 5.73 | 2.5 | |
| 5 | 4.12 | 2.93 | 2.32 | N-SF5 |
| 6 | 2.82 | 28.31 | 1.62 | |

### EXAMPLE 9

### Laser Receiver System Optics

In this example, a scene is to the left, a detector is to the right, and HFOV=0.062, EBR=10, EFL=90.9, and the object distance is infinity. System data is in Table 10. Surfaces 3-4 are conic sections, and conic constants are listed in Table 11.

TABLE 10

| | | | Aperture | |
|---|---|---|---|---|
| Surface | Radius | Thickness | Radius | Medium |
| 1 | 25.71 | 3 | 10 | N-LAK14 |
| 2 | 980.59 | 36.91 | 9.53 | |
| 3 | 0.38 | 1 | 0.9 | N-SF5 |
| 4 | −0.38 | 1.41 | 0.9 | |

TABLE 11

| Surface | Conic Constant |
|---|---|
| 3 | −3.47 |
| 4 | −3.47 |

### EXAMPLE 10

### Laser Receive System Optics

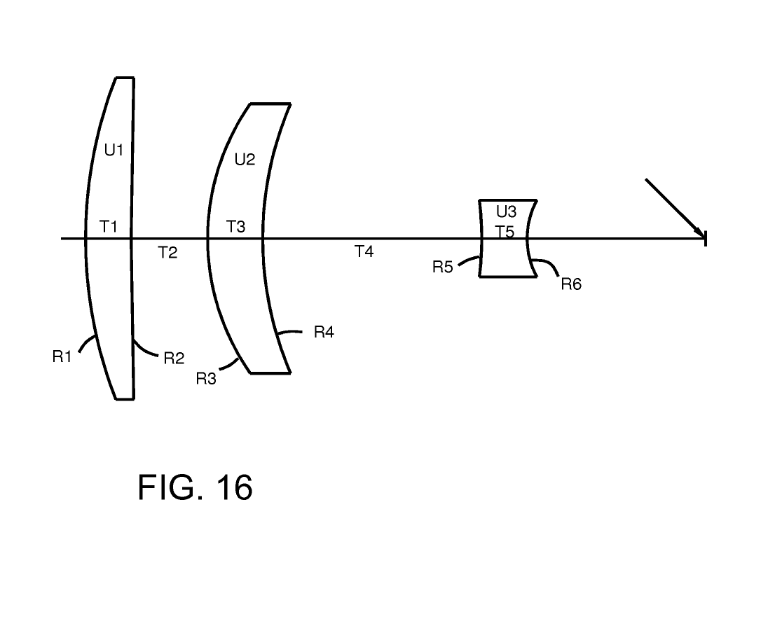

In this example, a scene is to the left, a detector is to the right as show in FIG. 16. In this example, HFOV=0.062, EBR=10, EFL=90.9, and object distance is infinity. System data is in Table 12.

TABLE 12

| | | | Aperture | |
|---|---|---|---|---|
| Surface | Radius | Thickness | Radius | Medium |
| 1 | 35.59 | 3.3 | 10.5 | N-SF11 |
| 2 | 376.78 | 5.56 | 10.5 | |
| 3 | 18.72 | 4 | 8.8 | N-SF11 |
| 4 | 27.21 | 15.9 | 8.8 | |
| 5 | −25.57 | 3.3 | 2.5 | N-SF11 |
| 6 | 6.43 | 12.96 | 2.5 | |

Having described and illustrated the principles of the disclosed technology with reference to the illustrated embodiments, it will be recognized that the illustrated embodiments can be modified in arrangement and detail without departing from such principles. For instance, elements of the illustrated embodiments shown in software may be implemented in hardware and vice-versa. Also, the technologies from any example can be combined with the technologies described in any one or more of the other examples. The particular arrangements above are provided for convenient illustration, and other arrangements can be used.

We claim:

1. A measuring device, comprising:
an objective lens defining an entrance pupil diameter Φ; and situated to form an image of a distant object at an image sensor; and
a display coupled to the image sensor and configured to produce a displayed image of the distant object based on the image formed by the objective lens; and
a first eye lens situated for user viewing of the displayed image, wherein the magnifying power of the distant object is at least 0.7× for each millimeter of the entrance pupil Φ).

2. The measuring device of claim 1, further comprising a laser transmitter configured to direct a probe beam to the distant object.

3. The measuring device of claim 1, further comprising an image processor configured to process the image from the image sensor so as to provide a selected digital zoom.

4. The measuring device of claim 1, further comprising:
an optical transmitter configured to produce optical radiation and direct at least a portion of the optical radiation to the distant object as a probe beam;
an optical receiver situated to receive a returned portion of the probe beam from the distant object; and
a rangefinding system configured to calculate a distance to the distant object based on the returned portion of the probe beam.

5. The measuring device of claim 4, further comprising:
a collimating lens situated to receive optical radiation from the optical transmitter and form the probe beam; and
a receiver lens situated to receive the returned portion of the probe beam and direct the returned portion to the optical receiver.

6. The measurement device of claim 4, wherein the rangefinding system is configured to calculate a speed associated with the distant object.

7. The measurement device of claim 4, wherein the laser rangefinder is configured to provide the estimate of distance based on a time of flight to and from the distant object.

8. The measurement device of claim 1, wherein the objective lens is situated so as to receive optical radiation from an optical transmitter and direct an probe beam to the distant target or to receive a returned portion of a probe beam and direct the returned portion to an optical receiver.

9. The measurement device of claim 1, wherein the objective lens is situated so as to receive optical radiation from an optical transmitter and direct an probe beam to the distant target and to receive a returned portion of a probe beam and direct the returned portion to an optical receiver.

10. The measurement device of claim 4, further comprising a ballistics processor and at least one environmental sensor, the ballistics processor configured to estimate a setting selected to produce an associated trajectory to the distant object based on an environmental parameter reported by the at least one environmental sensor.

11. The measurement device of claim 10, wherein the at least one environmental sensor is an inclinometer, barometer, thermometer, hygrometer, magnetometer, or a gyroscope.

12. The measurement device of claim 1, further comprising an image stabilizer configured to stabilize the image of the distant object with respect to the image sensor.

13. The measurement device of claim 1, further comprising a target tracking processor configured to initiate a distance measurement to the distant target based upon detection of the image of the distant target at the image sensor.

14. The measurement device of claim 13, wherein the tracking processor is configured to initiate the distance measurement upon detection of the image of the distant target at a predetermined portion of the image sensor.

15. The measurement device of claim 4, wherein the display is further configured to display a location of the probe beam at the distant target.

16. The measurement device of claim 15, wherein the image sensor includes first and second image sensors, wherein the first image sensor is configured to receive a visible image of the distant object and the second image sensor is configured to produce an alternative image associated with at least one of the distant object and the probe beam, and the display is configured to receive the visible and infrared images and display a combined image, the visible image, or the alternative image.

17. The measurement device of claim 16, wherein the alternative image is a visible image, an infrared image, or a thermal image provided by a visible sensor, an infrared sensor, or a thermal sensor, respectively.

18. The measurement device of claim 1, further comprising a second eye lens situated for user viewing of the displayed image, wherein the first and second eye lenses are spaced so as to provide first and second viewable images to first and second eyes of a user, respectively, wherein the first and second viewable images have a common magnification.

19. The measurement device of claim 18, wherein the first and second viewable images are based on the displayed image.

20. The measurement device of claim 19, wherein the first and second viewable images are associated with the displayed image on the image sensor and an additional displayed image on an additional image sensor so as to produce a stereoscopic image.
